(19) United States
(12) Patent Application Publication
(10) Pub. No.: US 2007/0111182 A1
(43) Pub. Date: May 17, 2007

(54) Method and system for distributing answers

(75) Inventors: Michael P. Outlaw, Dallas, GA (US); Matthew B. Trevathan, Kennesaw, GA (US)

Correspondence Address: GREENBLUM & BERNSTEIN, P.L.C., 1950 ROLAND CLARKE PLACE, RESTON, VA, 20191, US

(73) Assignee: International Business Machines Corporation, Armonk, NY (US)

(21) Appl. No.: 11/258,110

(22) Filed: Oct. 26, 2005

(51) Int. Cl. G09B 3/00

(52) U.S. Cl. 434/350

(57) ABSTRACT

A method and system comprises tagging correct answers to each of a plurality of questions in order to associate the each of the correct answers to a respective one of the plurality of questions. The system and method further comprises providing an objective criteria for distributing the correct answers for each of the plurality of questions amongst the plurality of questions and distributing the correct answers with relation to one another and the plurality of questions using the objective criteria.

### FIELD OF THE INVENTION

The invention generally relates to a method and system of distributing answers and, more particularly, to a method and system for distributing test answers in a randomized, weighted or other predetermined order for a standardized test or questionnaire, as one example.

### BACKGROUND OF INVENTION

Standardized tests are widely viewed as an objective measure of student achievement and have thus gained widespread acceptance throughout academia. These standardized tests include, for example, norm-referenced tests, criterion-referenced tests, mental ability tests, special placement tests, and aptitude tests, among others. Specific types of standardized tests include, to name a few, LSAT, SAT and MCATS, etc., in addition to a host of tests associated with the “No Child Left Behind” program mandated by the U.S. federal government.

These and other standardized tests typically include a number of questions prepared by a teaching professional or a group of educators. In preparing these tests, for each question, there are a number of answers, usually lettered “A” through “E”. In the current manner of preparing these multiple choice tests, though, the letter (or number) of the correct answer is selected by the person creating the test. However, this can lead to a conscious bias to one particular letter or number.

To aid the student in taking, passing and excelling in these standardized tests, an entire industry has evolved. This industry has developed many effective skills and strategies for approaching standardized testing, important to the student in gaining an advantage when taking such standardized test. Basically, these testing strategies attempt to eliminate giving up points needlessly due to undisciplined testing behavior, irrational responses to test items, or some combination of other counter productive habits. According to test preparation professionals, these strategies serve to equalize the opportunity for all students as well as improve the validity of test results.

These testing strategies and skills may include, amongst others, to follow directions closely, practice using test item formats, review practice items and answers, review questions very carefully noting certain keywords, and practice using answer sheets, all in order to familiarize the student with the particular test. These strategies and skills have been shown to improve testing confidence and hence increase testing scores by making the student more comfortable with the testing situation and format, as well as the opportunity to practice their test-taking skills to refine their abilities.

Further strategies include teaching the student to realize that standardized tests are constructed in such a manner that:
some items are challenging for even the best students;
no one is expected to answer all the items correctly;
there may be a non-randomized order to the answers; and
the selection of certain letter answers, e.g., “C”, when the student is not sure of the correct answer may increase the probability of answering the question correctly.

As to the latter strategy, for example, it is well-known that one strategy is to direct the student to always select one letter (or number) for questions they do not know and need to guess. This latter strategy is based on the bias of the test preparer, as discussed above.

Additionally, although it sounds like an urban legend, there is some legitimacy to the strategy that one letter answer, e.g., “C”, is usually used in a test more so than other letters. In such instances, a student which would otherwise not be able to make a passing grade may obtain a passing grade by at least obtaining a correct answer for some portion of the questions by choosing, e.g., “C”. People have even been known to pass tests without trying by simply selecting the same answer for every question, e.g., selecting the same letter answer.

### SUMMARY OF THE INVENTION

In an aspect of the invention, a system and method comprises tagging correct answers to each of a plurality of questions in order to associate the each of the correct answers to a respective one of the plurality of questions. The system and method further comprises providing an objective criteria for distributing the correct answers for each of the plurality of questions amongst the plurality of questions and distributing the correct answers with relation to one another and the plurality of questions using the objective criteria.

In another aspect of the invention, a system and method comprises associating correct answers and a plurality of incorrect answers to each question of a plurality of questions, and associating a letter or number with each of the correct answers based on a distribution across a total sum of the plurality of questions. The distribution may be based on at least a random distribution, a weighted distribution, a predefined pattern or an equal distribution.

In another aspect of the invention, a computer program product comprising a computer usable medium having readable program code embodied in the medium is provided. The computer program product includes at least one component to:
tag correct answers to each of a plurality of questions in order to associate the each of the correct answers to a respective one of the plurality of questions;
provide an objective criteria for distributing the correct answers for each of the plurality of questions amongst the plurality of questions; and

distribute the correct answers with relation to one another and the plurality of questions using the objective criteria.

### BRIEF DESCRIPTION OF THE DRAWINGS

FIG. 1 is a block diagram of an embodiment in accordance with the invention;

FIG. 2 is flow diagram implementing the step of the invention;

FIG. 3 is a flow diagram of an embodiment showing steps of using the invention; and

FIG. 4 shows a representative standardized answer sheet for a multiple choice exam in accordance with the invention.

### DETAILED DESCRIPTION OF EMBODIMENTS OF THE INVENTION

The invention is directed to a method and system for ensuring that each letter or number associated with a correct answer of a test or questionnaire will have a certain distribution across a total sum of the questions. This distribution may be, for example, a random distribution, a weighted distribution for each section, subsection or the like, as well as an equal distribution, to name a few. For example, by implementing the invention, each letter or number would be used for an equal number of times or have a weighted distribution, depending on the particular criteria set forth by the test author. Accordingly, the implementation of the invention makes it more difficult for a person taking the test to significantly increase his/her grade simply by selecting one answer for every question.

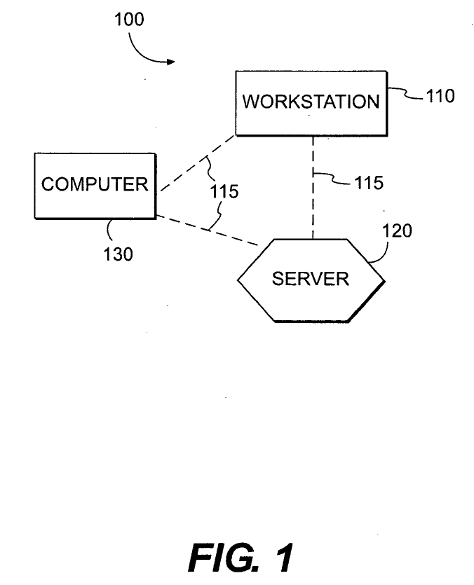

FIG. 1 is a block diagram of an embodiment illustrating the invention, generally denoted by reference numeral 100. The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

Being more specific and referring to FIG. 1, the invention includes at least one user workstation 110 which typically has a memory device (e.g., a hard drive, DVD drive, or the like) with processing capability and accompanying hardware and/or software, well-known to those of skill in the art. The user workstation 110 may be connected via a network 115 (e.g., a local area network (LAN), a wide area network (WAN), wireless network, or the Internet) to one or more servers 120. For illustrative purposes, the server 120 is representative of content sources which one of ordinary skill in the art would recognize may be any number of servers and may be different content sources such as, for example, DB2 databases, Web sites, or the like.

Still referring to FIG. 1, a computer used to score tests is also provided. The computer 130 may be connected via the network 115 to the workstation 110 and/or server 120. For illustrative purposes, the computer 130 may be programmed with the correct answers to a test for scoring the test in an efficient manner. In the implementation of FIG. 1, the computer may be programmed with the correct answers as the test (or questionnaire) is being generated, by either the workstation 110 or the server 120.

In the environment thus described, the author can begin authoring a test (or questionnaire) by preparing questions and accompanying answers. This can be accomplished, in one illustrative example, by entering such data into the client workstation 110 and tagging the correct answer to each question (which can be provided by the user or automatically by the system). This will associate the correct answer with the appropriate question. The data can then be transmitted to a server 120 via the network 115 for storage, and more specifically to populate a database or remain in a flat file. Alternatively, the data may remain resident on the client workstation 110 to populate the database or remain in a flat file. Once the data is entered, it may be accessed via the Internet and more particularly the World Wide Web, the client workstation 110, be printed or the like.

In one illustrative example, the author may select any of the following options for the distribution of the correct answers when preparing the test, all of which may be implemented on either hardware or on a computer program product. These options include:
using an even distribution throughout the standardized test;
using an even distribution within sections of the standardized test, e.g., mathematics section and English section;
defining a particular pattern throughout or within sections of the standardized test;
placing a particular weight on a particular letter or number associated with the correct answer; and/or
randomly generate a distribution amongst the correct answers.
   By way of example, for a hundred question test, each letter, “A” through “E”, may be equally used 20%, in a completely random order using a pseudorandom generator, known to those of skill in the art. These options may be implemented on computer program product comprising a computer usable medium having readable program code embodied in the medium.

The computer 130 can be programmed to scan the answer sheet and to determine the response to each question and thereafter determine the overall score for the test. In embodiments, it is contemplated that the computer 130 can be programmed with a particular key code, e.g., “ABC”, such that a user can select the key code for a particular test at which time the computer 130 would correlate that code with the test prior to the scoring thereof.

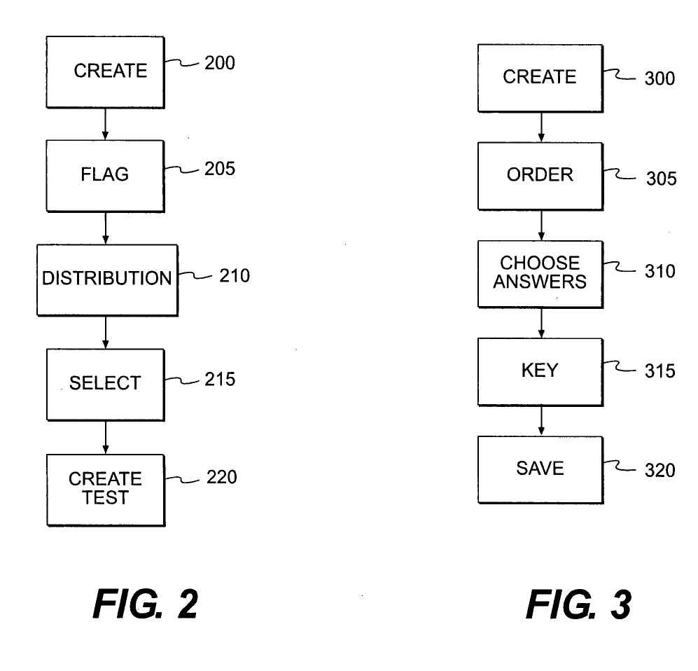

FIG. 2 is a flow diagram of an embodiment of the invention. FIG. 2 (as well as any remaining flow diagrams) may also be representative of a high level block diagram showing a high level system of the invention. The steps described herein are directed to a specific embodiment, e.g., a standardized test; however, it should be well understood by those of skill in the art that the present invention may equally be applicable to other environments such as, for example, questionnaires. The steps of FIG. 2 (as well as any flow diagrams described herein) may be implemented as computer program code in combination with the appropriate hardware. This computer program code may be stored on storage media such as a diskette, hard disk, CD-ROM, DVD-ROM or tape, as well as a memory storage device or collection of memory storage devices such as read-only memory (ROM) or random access memory (RAM). Additionally, the computer program code can be transferred to a workstation over the Internet or some other type of network. The computer readable code may be combined with the appropriate hardware and/or computing platform (which may be distributed software and hardware components, either new or pre-existing) for executing certain steps of the invention.

Continuing with the flow of FIG. 2, at step 200, the test author creates a multiple choice test by inputting the question with a correct answer and the incorrect answers. The order that the answers are inputted is insignificant and will not have any impact of the order of the final answers. At step 205, the test author (or system) may flag or tag the correct answer associated with each question; that is, the test author may associate the correct answer to each question. After the test author (or system) has completed the authoring process, the total number of questions divided by the average number of answers may be used to provide a distribution spread, at step 210. At step 215, the test author selects one of several options (objective criteria) for creating the final test, e.g., randomize, weighted, etc. In the example, of FIG. 2, the test author selects a random distribution spread, at step 215. This option may be randomly selected by the system. At step 220, the answers are provided in a pattern for the set of questions. The questions may be provided in a different order over a predefined set of displaying times.

In the alternative embodiment, the author (or system) can opt to have the distribution spread calculated across sub-sections, at step 215. For example, if the test comprises an English section and mathematics section, the author might have a different number of answers calculated for each section. This would allow test sections that have a different number of answers to not have an adverse effect on the average number of answers.

By way of illustration and expanding upon the English and mathematics example, the English section could have an average of three answers, one correct and two incorrect answers; whereas, the mathematics section could have an average of five answers. Therefore, on a one hundred question test, 50% English and 50% mathematics, the English distribution would be 16.5% of each answer, A-C, while the mathematics section would have a distribution of 10% of each answer, A-E.

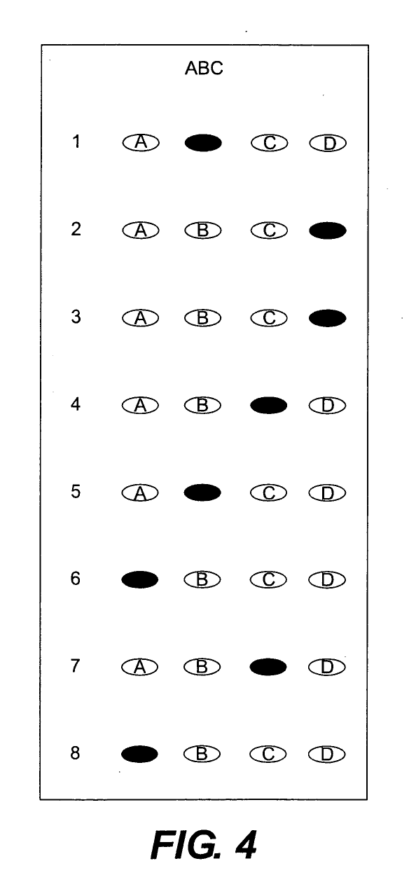

In a further embodiment, referring to FIG. 3, the author (or system) can create a test at step 300, similar to that noted above. The author (or system) can then opt to have the questions placed in a random order or the same order for each test generated, at step 305. In either situation, for each test, the author can choose to have different, randomized, weighted or patterned orders of the answers for all or a predetermined amount of the tests, at step 310.

In this and other embodiments disclosed herein, the author can also opt to assign a code or key to each test or set of tests, in order to more easily associate the generated test with the appropriate answer key, at step 315. This latter step allows a grader to more easily grade the test, and may also allow a grader to make any correlations between different variations of the test, e.g., conduct statistical analysis between different test patterns. The test and any chosen options may also be saved at step 320, for later access and/or use.

Once the test is generated, it is contemplated that the system of the invention can maintain a database or flat file of created tests and associated options chosen by the author. A subsequent user of the system can request a list of the tests stored in the database (or flat file) such that the system responds by presenting a list of the tests. The tests can then be accessed on the World Wide Web or an individual workstation or printed for use.

FIG. 4 shows a representative standardized answer sheet for a multiple choice exam in accordance with the invention. In this example, the author chose the option of weighting the correct answers evenly and presented in a random order. The answer sheet also shows a key code “ABC”, which is associated with a particular test. This key code can then be associated with the particular test for ease of grading or providing a statistical analysis or the like.

The answer sheet as shown in FIG. 4, as one illustrative representative example, can be scored by automated scoring systems quickly, efficiently, and accurately. For example, the computer 130 can be programmed to scan the answer sheet and to determine the response to each question. For example, each correct answer to each question can be stored in a computer database and the computer 130 can be programmed to compare the response against the correct answer, and thereafter determine the overall score for the test. In one implementation, the computer 130 can be programmed with the correct responses at the same time that the test (or questionnaire) is being generated, all particular to the specific selected option. Also, in embodiments, it is contemplated that the computer 130 can be programmed with the particular key code, e.g., “ABC” such that a user can select the key code for a particular test (or questionnaire) prior to the scoring process.

In another embodiment, the invention provides a business method that performs the process steps of the invention on a subscription, advertising, and/or fee basis. That is, a service provider, such as a Solution Integrator, could offer to system and method of distributing answers. In this case, the service provider can create, maintain, support, etc., a computer infrastructure that performs the process steps of the invention for one or more customers. In return, the service provider can receive payment from the customer(s) under a subscription and/or fee agreement and/or the service provider can receive payment from the sale of advertising content to one or more third parties.

While the invention has been described in terms of embodiments, those skilled in the art will recognize that the invention can be practiced with modifications and in the spirit and scope of the appended claims.

What is claimed is:

1. A method, comprising:
tagging correct answers to each of a plurality of questions in order to associate each of the correct answers to a respective one of the plurality of questions;
providing an objective criteria for distributing the correct answers for the each of the plurality of questions amongst the plurality of questions; and
distributing the correct answers with relation to one another and the plurality of questions using the objective criteria.

2. The method of claim 1, wherein the distributing is across a total sum of the plurality of questions or a predefined subset of the plurality of questions.

3. The method of claim 1, further comprising associating a letter or number with each correct answer of the respective questions, wherein the letter or number has a predetermined distribution across a total sum of the plurality of questions.

4. The method of claim 1, wherein the distributing comprises one of a random distribution, a weighted distribution, a predefined pattern or an equal distribution across a total sum of the questions and a predefined subset of the plurality of questions.

5. The method of claim 1, further comprising displaying the plurality of questions with the correct answers for each of the plurality of questions distributed according to the objective criteria.

6. The method of claim 1, wherein the steps of claim 1 are performed entirely with software elements, hardware elements or both hardware elements and software elements.

7. The method of claim 6, wherein the software elements are at least one of firmware, resident software and microcode.

8. The method of claim 1, wherein the distributing step is implemented on a computer program product accessible from a computer-usable or computer-readable medium providing program code for use by or in connection with a computer or an instruction execution system.

9. The method of claim 1, further comprising storing the correct answers with relation to one another and the plurality of questions in one of a database and a flat file.

10. The method of claim 1, further comprising providing access to the correct answers with relation to one another and the plurality of questions from a remote server over a network.

11. The method of claim 1, further comprising providing the plurality of questions in a different order over a predefined set of displaying times.

12. The method of claim 1, wherein the plurality of questions comprise one or more standardized tests.

13. The method of claim 12, further comprising assigning a code or key to associate the one or more standardized tests with the plurality of questions.

14. The method of claim 13, further comprising conducting a statistical analysis to make correlations between different variations of the one or more standardized tests.

15. The method of claim 1, further comprising allowing subsequent users access to a list stored in a database or flat file of the one or more standardized tests.

16. The method of claim 1, further comprising programming a computer to score an answer sheet based on the distribution of the correct answers.

17. A method of creating a test, comprising associating a correct answer and a plurality of incorrect answers to each question of a plurality of questions; and associating a letter or number with the correct answer for each question based on a distribution across a total sum of the plurality of questions by at least a random distribution, a weighted distribution, a predefined pattern or an equal distribution and displaying the correct answers according to the distribution.

18. The method of claim 17, wherein the distribution is implemented on a computer program product accessible from a computer-usable or computer-readable medium providing program code for use by or in connection with a computer or an instruction execution system.

19. The method of claim 17, further comprising storing the distribution of the correct answers with relation to one another in one of a database and a flat file.

20. The method of claim 17, further comprising providing access to the test from a remote server over a network.

21. The method of claim 17, further comprising providing the questions in a different order over a predefined set of displaying times.

22. The method of claim 17, further comprising assigning a code or key to associate the test with the plurality of questions.

23. The method of claim 17, further comprising allowing subsequent users access to a list stored in a database or flat file associated with the test.

24. The method of claim 17, further comprising programming a computer to score an answer sheet based on the distribution of the correct answers.

25. A system, comprising:
means for associating a correct answer and a plurality of incorrect answers to each question of a plurality of questions;
means for associating a letter or number with the correct answer based on a distribution across a total sum of the plurality of questions by at least a random distribution, a weighted distribution, a predefined pattern or an equal distribution; and
means for displaying the correct answer according to the distribution.

26. A computer program product comprising a computer usable medium having readable program code embodied in the medium, the computer program product includes at least one component to:
tag correct answers to each of a plurality of questions in order to associate the each of the correct answers to a respective one of the plurality of questions;
provide an objective criteria for distributing the correct answers for each of the plurality of questions amongst the plurality of questions; and
distribute the correct answers with relation to one another and the plurality of questions using the objective criteria.

27. A process for integrating computing infrastructure, comprising integrating computer-readable code into a computer system, wherein the computer system comprises a computer usable medium, wherein said computer usable medium comprises distributing answers, and wherein the code in combination with the computer system is capable of performing a method comprising:
tag correct answers to each of a plurality of questions in order to associate the each of the correct answers to a respective one of the plurality of questions;
provide an objective criteria for distributing the correct answers for each of the plurality of questions amongst the plurality of questions; and
distribute the correct answers with relation to one another and the plurality of questions using the objective criteria.
